(19) United States
(12) Patent Application Publication
(10) Pub. No.: US 2025/0132105 A1
(43) Pub. Date: Apr. 24, 2025

(54) HV/MV SWITCH CONTACTS ARRANGEMENT

(71) Applicant: ABB Schweiz AG, Baden (CH)

(72) Inventors: Pierluigi Invernizzi, Corna Imagna (BG) (IT); Simone Rambaldini, Paderno Dugnano (MI) (IT)

(21) Appl. No.: 18/918,634

(22) Filed: Oct. 17, 2024

(30) Foreign Application Priority Data
Oct. 18, 2023 (EP) 23204480.0

(51) Int. Cl. H01H 1/14

(52) U.S. Cl. CPC H01H 1/14

(57) ABSTRACT

A switch contacts arrangement comprising a fixed assembly and a movable assembly couplable to said fixed assembly between a closed/open position. The fixed assembly comprises: a main contact group and a pre-arching contact element comprising a central contact pin centrally positioned in a contact seat and having a terminal portion protruding outside said contact seat. The movable assembly comprises a main contact element having a body with a contact end configured to be inserted into said contact seat with a movement, the external surface of said contact end in electrical contact with said main contact elements when inserted into said contact seat. The contact end comprises an opening and a longitudinal channel for housing the central contact pin and further comprises one or more transversal channel(s) conveying a quenching gas from the outside of the main contact element into said longitudinal channel during the opening operation of said movable assembly.

### CROSS-REFERENCE TO RELATED APPLICATIONS

The present application claims priority to European Patent Application No. 23204480, filed on Oct. 18, 2023, and titled “HV/MV SWITCH CONTACTS ARRANGEMENT”, which is hereby incorporated by reference in its entirety.

### TECHNICAL FIELD

The present disclosure relates to a contacts arrangement for a High and Medium Voltage switch and to a High and Medium Voltage switching unit comprising such contacts arrangement. More in particular, the present disclosure relates to an improved contacts arrangement provided with arc suppression capabilities and to a High and Medium Voltage switch, in particular a MV fast earthing switch equipped with such improved contacts arrangement.

### BACKGROUND

For the purposes of the present disclosure, the term Medium Voltage is intended to designate electrical systems operating at voltage levels higher than 1 kV AC and 1.5 kV DC up to some tens of kV, e.g., up to 72 kV AC and 100 kV DC.

Medium Voltage switches, in particular disconnector and earthing switches, equipped with a movable and fixed contacts assembly are well known in the art and are normally used, e.g., to electrically connect a supply terminal with a load terminal, or a load terminal to earth. The movable contact is normally designed to move, linearly or rotationally, between an open position in which it is separated from the corresponding fixed contact and a closed position in which it electrically coupled with the fixed contact.

According to solutions well known in the art, traditional Medium Voltage switches have been normally positioned inside a pressurized tank filled with a sulphur hexafluoride (SF₆) atmosphere, as this insulation gas ensures excellent performances in terms of dielectric insulation and arc-quenching capabilities when currents are interrupted.

As is known, however, SF₆ is a very potent greenhouse gas, and its use is subject to severe restrictions for environmental preservation purposes. For this reason, over the years, there has been made a considerable effort to design Medium Voltage switches not employing SF₆ as an insulation gas.

In the most recent Medium Voltage switches, SF₆ has been substituted by other gases, e.g., pressurized dry air, which however have lower insulating properties with respect to SF₆.

The design of a Medium Voltage switch should therefore take into account, in addition to the other operative requirements, the requirements deriving from the use of insulating gases other than SF₆.

The design requirements that need to be satisfied can be very different depending on the application, but, in general, it would be desirable for the MV switch to have—for instance—a compact design, a sufficiently fast closing and opening operation, and the possibility to avoid, or to minimize, arching phenomena during the opening/closing operation.

Moreover, for certain applications, it would be desirable to combine the MV switch capabilities, e.g., the fast-earthing capabilities, with other functionalities, e.g., making and/or breaking capabilities, even at relatively high nominal operating voltage, such as around 72 kV AC, and relatively high rated currents, such as around 25 kA.

### BRIEF DESCRIPTION

The main aim of the present disclosure is to provide a High and Medium Voltage switch, in particular a High and Medium Voltage fast-earthing switch, which allows overcoming or mitigating the drawbacks of the known art.

Within this aim, a purpose of the present disclosure is to provide a contacts arrangement for a High and Medium Voltage switch, in particular a High and Medium Voltage fast-earthing switch, which has a compact design.

A further purpose of the present disclosure is to provide a contacts arrangement for a High and Medium Voltage switch, in particular a High and Medium Voltage fast-earthing switch, which is provided with fast closing and fast opening functions.

A further purpose of the present disclosure is to provide a contacts arrangement for a High and Medium Voltage switch, in particular a High and Medium Voltage fast-earthing switch, which is also provided with making capabilities.

A further purpose of the present disclosure is to provide a contacts arrangement for a High and Medium Voltage switch, in particular a High and Medium Voltage fast-earthing switch, which is also provided with capacitive and inductive breaking capabilities.

A further purpose of the present disclosure is to provide a contacts arrangement for a High and Medium Voltage switch, in particular a High and Medium Voltage fast-earthing switch, which is able to operate at relatively high nominal operating voltages and relatively high rated currents.

A further purpose of the present disclosure is to provide a contacts arrangement for a High and Medium Voltage switch, in particular a High and Medium Voltage fast-earthing switch, which has a simple and compact structure with a relatively low number of components.

A further purpose of the present disclosure is to provide a contacts arrangement for a High and Medium Voltage switch, in particular a High and Medium Voltage fast-earthing switch, which is relatively simple and cheap to be manufactured at industrial levels.

The above aim and purposes, as well as other purposes that will emerge clearly from the following description and attached drawings, are provided, according to the present disclosure, by a contacts arrangement for a High and Medium Voltage switch, in particular a High and Medium Voltage fast-earthing switch, according to the following claim 1 and the related dependent claims.

In a further aspect, the present disclosure also relates to a High and Medium Voltage switch, in particular a High and Medium Voltage fast-earthing switch, which comprises a contacts arrangement as described herein.

In a general definition of the disclosure, the contacts arrangement for a High and Medium Voltage switch, in particular a High and Medium Voltage fast-earthing switch, comprises a fixed contact assembly and a movable contact assembly which is couplable to and un-couplable from said fixed contact assembly between a closed and an open position.

In particular, the fixed contact assembly comprises: a main contact group which comprises a support element having a plurality of main contact elements circumferentially positioned to delimit a contact seat, and a pre-arching contact element which comprises a central contact pin centrally positioned in said contact seat and having a terminal portion protruding outside said contact seat.

In turn, the movable contact assembly generally comprises a main contact element having an elongated body with a contact end portion which is adapted to be inserted into and extracted from said contact seat with a linear movement. The external surface of the contact end portion of the main contact element of the movable contact assembly is adapted to be in electrical contact with the main contact elements of the fixed contact assembly when inserted into said contact seat.

The contacts arrangement for a High and Medium Voltage switch of the present disclosure is characterized in that the contact end portion of the main contact element of the movable contact assembly comprises a first longitudinal channel which is adapted for housing the central contact pin of said movable contact assembly and further comprises one or more transversal channel(s) conveying an arc suppression gas from the outside of the main contact element of the movable contact assembly into said first longitudinal channel at least during the opening operation of said movable contact assembly.

For the purposes of the present disclosure, the term “central contact pin” is meant to designate in general a shaped elongated body of conductive material which has a base end rigidly and electrically coupled to the support element of the main contact group of the fixed contact assembly, and a terminal portion protruding outside said contact seat.

Also, for the purposes of the present disclosure, the term “longitudinal” is meant to designate a direction substantially parallel to the linear movement of the main contact element of the movable contact assembly.

Moreover, for the purposes of the present disclosure, the term “arc suppression gas” is meant to designate a gas or a mixture of gases—such as pressurized dry air or an environment—friendly insulation gas, such as mixtures of oxygen, nitrogen, carbon dioxide and/or fluorinated gases—which may have a suppression effect on the arc due to the chemical and physical features—e.g., flow, flow rate, pressure and speed—of the gas stream flowing in the transversal channel(s) of the contact end portion of the main contact element of the movable contact assembly.

In this way, as better described hereinafter, in the contacts arrangement for a High and Medium Voltage switch of the present disclosure, the design of the contact system—and in particular of the movable contact assembly—provides an efficient system for controlling the arc phenomena during operation, in particular during the opening operation of the movable contact assembly. In this way, a High and Medium Voltage fast-earthing switch provided with the herein disclosed contacts arrangement is also endowed with breaking capabilities, thereby enhancing its functionalities and its range of applications.

Indeed, it has been found that the combination of fast closing and fast opening functions together with the making capabilities and capacitive and inductive breaking capabilities makes a High and Medium Voltage fast-earthing switch equipped with the herein disclosed contacts arrangement suitable for use over a broad range of operating conditions, including relatively high nominal operating voltages, such as around 72 kV AC, and relatively high rated currents, such as around 25 kA, or higher.

At the same time, the substantially linear movement of the movable contact allows obtaining a very compact overall design of High and Medium Voltage fast-earthing switch, making it suitable for use in modern HV/MV switchgears which make little or no use of SF₆ as insulating gas.

In general, in the contacts arrangement of the present disclosure, the fixed contact assembly may conveniently be of the so-called “tulip” type. Tulip-type contact systems are well known in the art and therefore will not be described with further details.

According to some embodiments of the contacts arrangement, the one or more transversal channel(s) formed in the main contact element of the movable contact assembly have an inlet section which is located on the external surface of the elongated body of the main contact element of the movable contact assembly and an outlet section on the internal surface of the first longitudinal channel positioned in the contact end portion of the main contact element of the movable contact assembly.

In practice, the arrangement of the transversal channel(s) is such that, during the opening operation of the movable contact, the arc suppression gas is forced (forward) into the transversal channel(s) as a consequence of the (backward) opening movement of the movable contact.

For the purposes of the present disclosure, the term “forward” is meant to indicate the linear direction of the movable contact during the closing operation, and the term “backward” is meant to indicate the linear direction of the movable contact during the opening operation.

Thus, as better explained in the following detailed description, in some embodiments of the contacts arrangement, the one or more transversal channel(s) may be inclined toward the opening of the contact end portion of the main contact element at an angle of less than 90°.

The number of the transversal channels which are formed in the body of the contact may vary depending on the actual design of the main contact element of the movable contact assembly and on the operating conditions of the intended use.

For instance, under certain circumstances, one single transversal channel may be sufficient to obtain a properly channelled flow of the arc suppressing gas in the areas of interest within the contact end portion of the main contact element of the movable contact assembly.

However, in general embodiments of the HV/MV switch contacts arrangement, the contact end portion of the main contact element of the movable contact assembly may be conveniently provided with a plurality of transversal channels.

Also, the positioning of the transversal channels which are formed in the body of the contact may vary depending on the actual design of the main contact element of the movable contact assembly and on the operating conditions of the intended use.

For instance, in some embodiments of the present disclosure, the contact end portion of the main contact element of the movable contact assembly may conveniently comprise a plurality of transversal channels which are symmetrically positioned with respect to the first longitudinal channel formed in said contact end portion.

In general, a symmetrical positioning of the transversal channels tends to generate in the first longitudinal channel flows of the arc suppressing gas which are constant and comparable and which are not adversely influenced by each other, as it may happen with transversal channels that have a different arrangement.

However, this does not limit the possibility of using transversal channels which are positioned in a different, non-symmetrical, way by giving them a proper arrangement and inclination, thus trying to sum up the air flows which can mutually influence each other in terms of speed and direction.

Moreover, it could also be possible to machine the internal surfaces of the first longitudinal channel formed in the contact end portion of the movable contact—or even add one or more insert(s) into it—so as to obtain different channelled flows of the arc suppressing gas from the transversal channels.

In general embodiments of the HV/MV switch contacts arrangement of the present disclosure, the internal surfaces of said one or more transversal channel(s) may conveniently have a converging profile.

In practice, it has been found that in order to obtain an effective “blowing” of the arc suppressing gas, it may be convenient to have a progressive reduction of the diameter of the transversal channels in order to increase the exit speed of the arc suppressing gas in the area of interest into the first longitudinal channel during the opening movement of the mobile contact assembly.

In practice, in embodiments of the HV/MV switch contacts arrangement, the area of the inlet section of the transversal channels from the outside of the main contact element of the movable contact assembly may be conveniently greater than the area of the corresponding outlet section into the first transversal channel.

Thus, in general, it can be said that in the HV/MV switch contacts arrangement, at least an outlet portion of said one or more transversal channel(s) into said first longitudinal channel is nozzle-shaped.

For the purposes of the present disclosure, the term “nozzle-shaped” is meant to indicate that the cross-sectional area of at least the outlet portion of the transversal channel(s) may vary so as to control the rate of flow, speed, direction, and/or the pressure of the stream of the arc suppressing gas that emerges from it.

According to some embodiments, better described in details hereinafter, the movable contact assembly of the HV/MV switch contacts arrangement comprises a conveyor element for conveying an arc suppressing gas from the outside of the main contact element to an inlet section of said one or more transversal channel(s).

In practice, according to this embodiment, the conveyor element has the function to collect the arc suppressing gas during the (backward) movement of the movable contact assembly in the opening operation and to convey (forward) such gas into said one or more transversal channel(s).

In particular, according to some embodiments, said conveyor element may conveniently form a closed cavity positioned on the external surface of the main movable contact element. Such cavity has an inlet opening in an opposite direction with respect to the contact end portion of the main contact element of the movable contact assembly (i.e. the inlet opening of the cavity faces toward the opening direction of the movable contact assembly). The inlet section(s) of said one or more transversal channel(s) are located on the base surface of said closed cavity (i.e., on the external surface of the main movable contact element). In this way, the arc suppressing gas flowing into the cavity thorough the inlet opening during the opening operations of the movable contact assembly are forced to enter into the one or more transversal channel(s) thorough their inlet section(s).

In general, shape and numbers of the conveyor element may vary depending on the design and positioning of the one or more transversal channel(s) within the contact end portion of the main contact element of the movable contact assembly.

A High and Medium Voltage switching unit comprising a contacts arrangement as described herein is also part of the present disclosure.

In particular, the High and Medium Voltage switch of the present disclosure may conveniently be a High and Medium Voltage fast-earthing switch.

Also, the High and Medium Voltage fast-earthing switch is normally provided with kinematic chains and transmission links between the movable contact assembly and an actuator that can be of any type, according to the needs and according to solutions well known in the art and therefore will not be described with further details.

### BRIEF DESCRIPTION OF DRAWINGS

Further features and advantages of the present disclosure will be more apparent from the description of non-limiting embodiments of the present disclosure, shown by way of examples in the accompanying drawings, wherein:

FIG. 1 is a first view of an embodiment of a contacts arrangement of a Medium Voltage fast-earthing switch, according to the present disclosure, shown in the closed position;

FIG. 2 is a second view of an embodiment of a contacts arrangement of a Medium Voltage fast-earthing switch, according to the present disclosure, shown in the open position;

FIG. 3 is first view of an embodiment of a movable contact assembly of a contacts arrangement for a Medium Voltage fast-earthing switch, according to the present disclosure;

FIG. 4 is second view of an embodiment of a movable contact assembly of a contacts arrangement for a Medium Voltage fast-earthing switch, according to the present disclosure;

FIG. 5 is section view in the transversal plane A of a detail of the embodiment of a movable contact assembly of a contacts arrangement for a Medium Voltage fast-earthing switch of FIG. 4;

FIG. 6 is first view of a further embodiment of a movable contact assembly of a contacts arrangement for a Medium Voltage fast-earthing switch, according to the present disclosure;

FIG. 7 is second view of a further embodiment of a movable contact assembly of a contacts arrangement for a Medium Voltage fast-earthing switch, according to the present disclosure;

FIG. 8 is section view in the transversal plane B-B of a detail of the embodiment of a movable contact assembly of a contacts arrangement for a Medium Voltage fast-earthing switch of FIG. 7.

### DETAILED DESCRIPTION

With reference to the attached figures, the present disclosure—in its more general definition—relates to a contacts arrangement 100, in particular, to a contacts arrangement 100 for a HV/MV fast earthing switch. In the attached figures reference is made to a MV fast earthing switch.

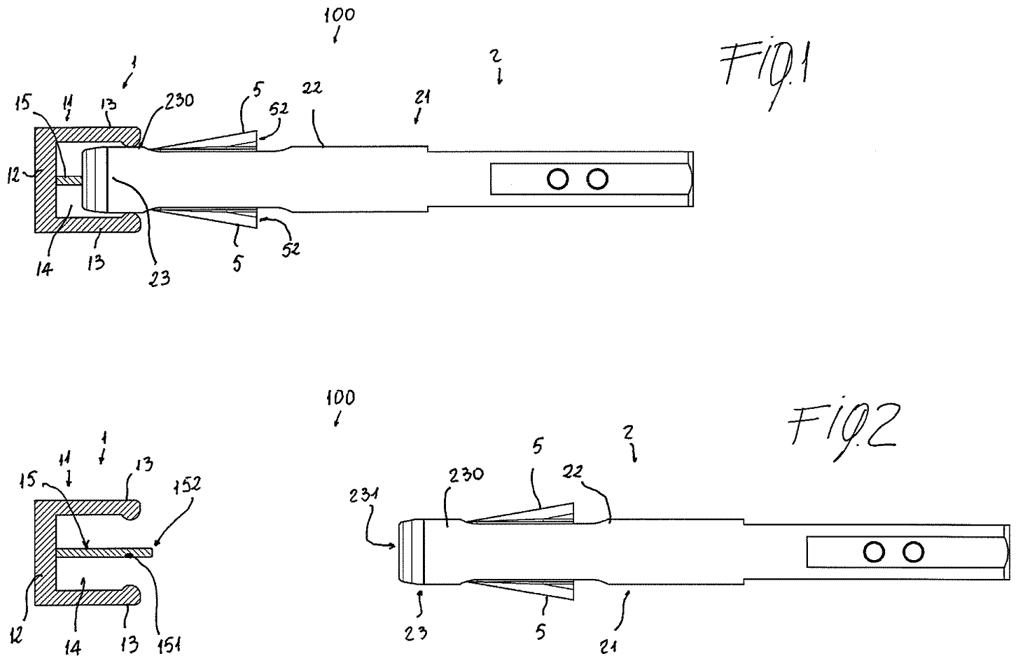

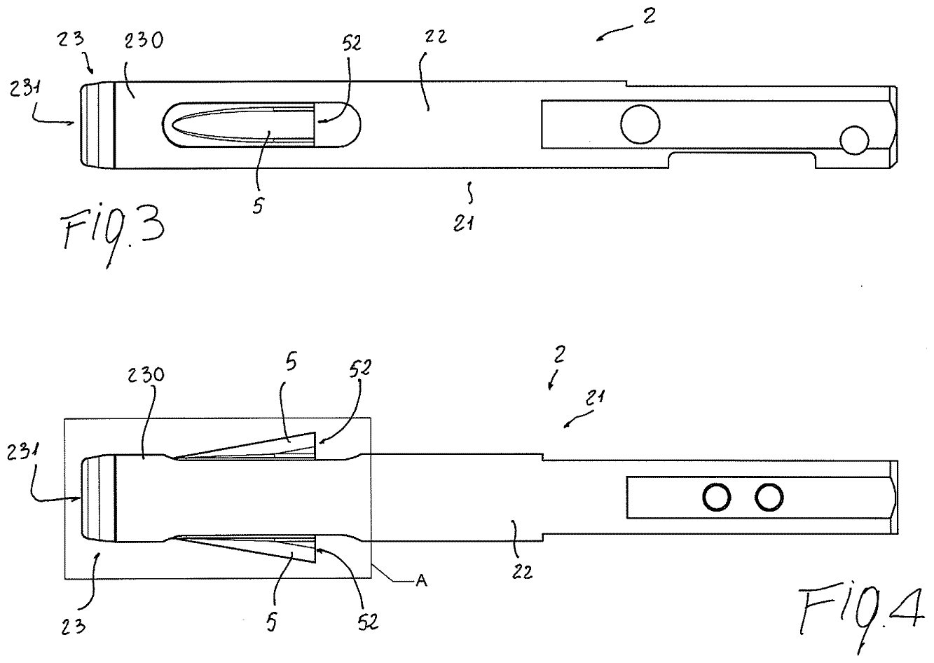

With reference to FIGS. 1 and 2, the contacts arrangement 100 comprises a fixed contact assembly 1 and a movable contact assembly 2. The movable contact assembly 2 is couplable to and un-couplable from the fixed contact assembly 1 between a closed position, as represented in FIG. 1, and an open position, represented in FIG. 2.

In the embodiments shown, the fixed contact assembly 1 comprises a main contact group 11 comprising a support element 12 having a plurality of main contact elements 13 which are circumferentially positioned to delimit a contact seat 14.

In practice, in the embodiments shown, the fixed contact assembly 1 is of the so-called “tulip” type and comprises a plurality of main contact fingers 13 conveniently shaped and positioned to delimit a substantially circular central contact seat 14.

A pre-arching contact element 15 comprising a central contact pin 151 of conductive material is centrally positioned in the contact seat 14 and is provided with a terminal portion 152 which protrudes outside the contact seat 14.

With reference also to the other Figures, the movable contact assembly 2 comprises a main contact element 21 which has an elongated body 22 with a contact end portion 23 that is adapted to be inserted into and extracted from the contact seat 14 of the fixed contact assembly 1 with a linear movement.

In particular, as shown in FIGS. 1 and 2, the external surface 230 of said contact end portion 23 of the movable contact assembly 2 is adapted to be in electrical contact with the main contact elements 13 of the fixed contact assembly 1 when it is inserted into the contact seat 14 of the fixed contact assembly 1.

Moreover, the contact end portion 23 of the main contact element 21 of the movable contact assembly 2 comprises an opening 231 and a first longitudinal channel 3 which is adapted for housing the central contact pin 151 of the movable contact assembly 1.

In general, the first longitudinal channel 3 is substantially parallel to the direction of the linear movement of the movable contact assembly 2 between the closed/open positions and is centrally positioned in the contact end portion 23 of the elongated body 22, i.e., centrally positioned with respect to the longitudinal axis of the contact end portion 23 of the elongated body 22.

Thus, in the closed condition of FIG. 1, the electrical contact between the fixed 1 and movable 2 contact assembly is mainly provided by the electrical contact between the external surface 230 of the contact end portion 23 of the movable contact assembly 2 and the main contact elements 13 of the fixed contact assembly 1, while the central contact pin 151 is housed inside the first longitudinal channel 3 formed in the contact end portion 23 of the movable contact assembly 2.

During the opening operation, the movable contact assembly 1 moves backward, i.e., toward the right-hand side of FIGS. 1.

In a first phase of the opening operation (not shown in the figures), the external surface 230 of the contact end portion 23 of the movable contact assembly 2 separates from the main contact elements 13 of the fixed contact assembly 1 while the central contact pin 151 remains in physical and electrical contact with the contact end portion 23 of the movable contact assembly 2, due to the fact that the terminal portion 152 of the contact pin 151 protrudes outside the contact seat 14 of the fixed contact assembly 1.

Then, continuing the opening operation, the terminal portion 152 of the contact pin 151 is extracted from the first longitudinal channel 3 of the contact end portion 23 of the main contact element 21 of the movable contact assembly 2, thereby interrupting the physical contact between the two, and an arc is generally struck at this point of the operation.

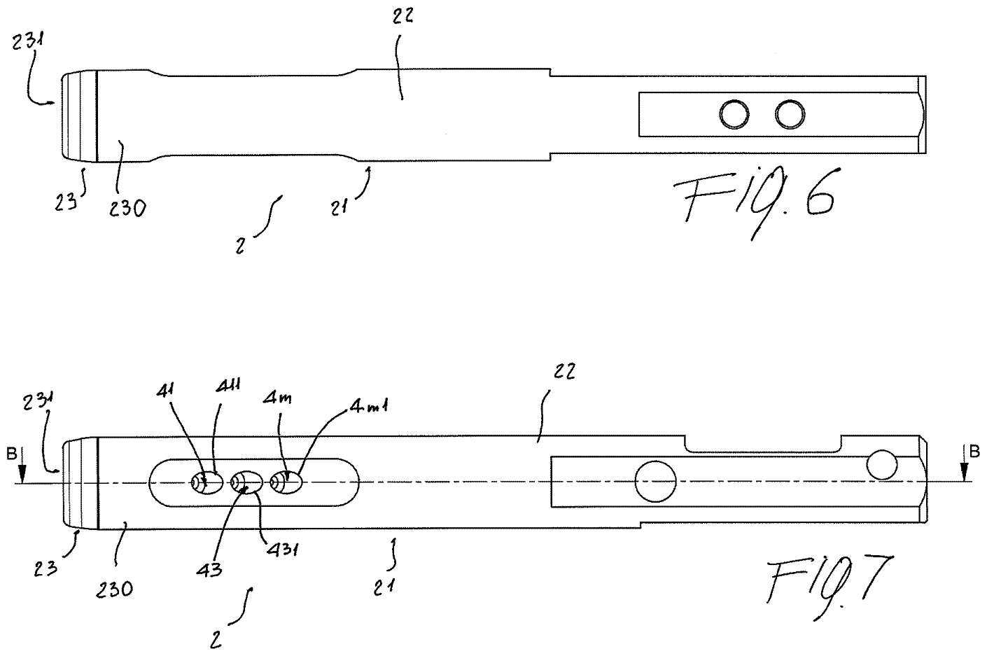

In order to minimize the arc duration and effects, the contact end portion 23 of the main contact element 21 of the movable contact assembly 2 is conveniently provided with one or more transversal channel(s) 41, 42, 43, 44, 4m, 4n having the purpose to convey an arc suppressing gas from the outside of the main contact element 21 of the movable contact assembly 2 into the first longitudinal channel 3, as shown in details in FIGS. 5 and 8.

In this way, the arc phenomena during the opening operation of the movable contact assembly 2 can be effectively controlled and the Medium Voltage fast-earthing switch equipped with this contacts arrangement 100 is effectively provided with breaking capabilities, thereby enhancing its functionalities and its range of applications.

As already said, the arc suppressing gas is generally constituted by the insulating gas used in the switchgear in which the Medium Voltage fast-earthing switch is positioned, and can be, for instance, pressurized dry air or an environment-friendly insulation gas, such as mixtures of oxygen, nitrogen, carbon dioxide and/or fluorinated gases.

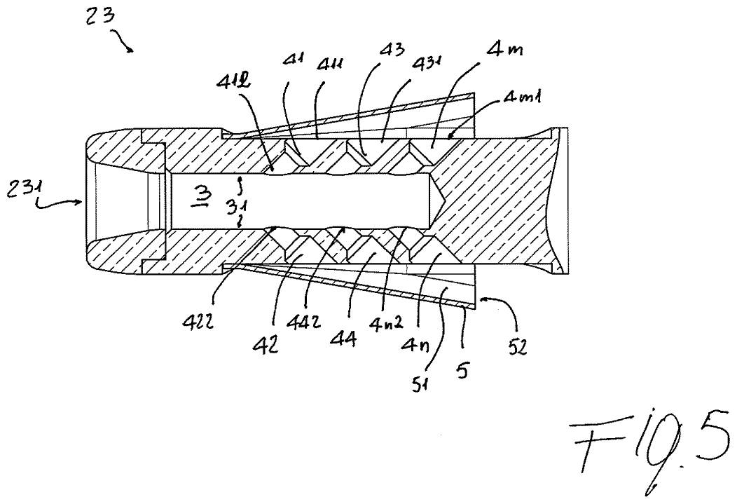

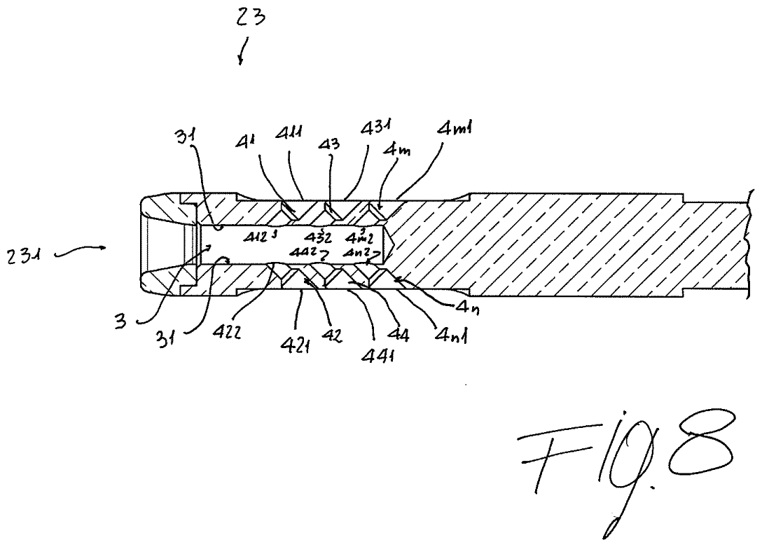

With particular reference to FIGS. 3-8, the one or more transversal channel(s) 41, 42, 43, 44, 4m, 4n have an inlet section 411, 421, 431, 441, 4m1, 4n1 which is located on the external surface of the elongated body 22 of the main contact element 21 of the movable contact assembly 2 and an outlet section 412, 422, 432, 442, 4m2, 4n2 which is located on the internal surface 31 of the first longitudinal channel 3.

As already briefly explained, the conveying of the arc suppressing gas into the first longitudinal channel 3 takes place as a consequence of the backward movement of the movable contact assembly 2.

In this regard, as shown in FIGS. 5 and 8, the arrangement of the transversal channel(s) 41, 42, 43, 44, 4m, 4n is such that, during the opening operation of the movable contact assembly 2, the arc suppression gas is forced forward (i.e., toward the left-hand side of the Figures) into the transversal channel(s) 41, 42, 43, 44, 4m, 4n, as a consequence of the backward opening movement (i.e., toward the right-hand side of the Figures) of the movable contact.

Thus, in the embodiments of the contacts arrangement shown in the attached figures, the transversal channel(s) 41, 42, 43, 44, 4m, 4n are inclined toward the opening 231 of the contact end portion 23 of the main contact element 22 at an angle of less than 90° with respect to the longitudinal axis of the channel 3.

Even if one single transversal channel may be sufficient to obtain a properly channelled flow of the arc suppressing gas in the areas of interest within the contact end portion of the main contact element of the movable contact assembly, some embodiments may have a plurality of transversal channels 41, 42, 43, 44, 4m, 4n.

In the embodiments shown in the attached figures, the movable contact assembly 2 is provided with a plurality of transversal channels 41, 42, 43, 44, 4m, 4n which are symmetrically positioned with respect to the first longitudinal channel 3.

In particular, in the embodiment shown, a first group of transversal channels 41, 43, 4m, is positioned on one side of the contact end portion 23 of the main contact element 21 of the movable contact assembly 2. Such transversal channels 41, 43, 4m are aligned in the longitudinal direction of the main contact element 21 (i.e., in the direction of movement of the movable contact assembly 2) with a constant pitch.

A second group of transversal channels 42, 44, 4n is positioned on the opposite side of the contact end portion 23 of the main contact element 21 of the movable contact assembly 2, i.e. at 180° with respect to the central longitudinal axis of the main contact element 21. The transversal channels 42, 44, 4n are aligned in the longitudinal direction of the main contact element 21 with a constant pitch, similarly to the transversal channels 41, 43, 4m of the first group.

In this way, the flows of the arc suppressing gas which are generated in the first longitudinal channel 3 during the opening operation of the movable contact 2 are constant and coherent and do adversely influence each other, thereby maximizing the arc suppression effect.

Other arrangement of the transversal channels 41, 42, 43, 44, 4m, 4n, symmetrical or non-symmetrical are however possible, in general.

With particular reference to the embodiments of FIGS. 5 and 8, the internal surfaces of the transversal channels 41, 42, 43, 44, 4m, 4n have a converging profile, i.e., there is a reduction of the diameter of the transversal channels 41, 42, 43, 44, 4m, 4n form the inlet point to the outlet point so as to obtain an increase of the exit speed of the arc suppressing gas from the transversal channels 41, 42, 43, 44, 4m, 4n.

In particular, in the embodiments shown, the area of the inlet section 411, 421, 431, 441, 4m1, 4n1 of the transversal channels 41, 42, 43, 44, 4m, 4n is greater than the area of the corresponding outlet section 412, 422, 432, 442, 4m2, 4n2, and this reduction of the section areas brings about the desired increase of speed of the arc suppressing gas in the area of interest into the first longitudinal channel 3 during the opening movement of the mobile contact assembly 2.

In practice, as previously said, at least an outlet portion 412, 422, 432, 442, 4m2, 4n2 of the transversal channels 41, 42, 43, 44, 4m, 4n into the first longitudinal channel 3 is nozzle-shaped, so mas to achieve the desired gas speed increase effect.

With reference to the embodiments of the MV switch contacts arrangement 100 shown in FIGS. 3-5, the movable contact assembly 2 comprises a conveyor element 5 for conveying an arc suppressing gas from the outside of the main contact element 21 to an inlet section 411, 421, 431, 441, 4m1, 4n1 of said transversal channels 41, 42, 43, 44, 4m, 4n.

In particular, the conveyor element 5 forms a closed cavity 51 which is positioned on the external surface of the main movable contact element 21. Such cavity 51 has an inlet opening 52 which is located in an opposite direction with respect to the contact end portion 23 of the main contact element 21 of the movable contact assembly 2.

In practice, as shown in the attached FIGS. 3-5, the inlet opening 52 of the cavity 51 faces toward the opening direction of the movable contact assembly 2, i.e., toward the right-hand side of the figures. The inlet sections 411, 421, 431, 441, 4m1, 4n1 of the transversal channels 41, 42, 43, 44, 4m, 4n are located on the base surface of said closed cavity 51, i.e., on the external surface of the main movable contact element 21.

In this way, during the opening operations of the movable contact assembly 2 (movement toward the right-hand side of the figures) the arc suppressing gas flows into the cavity 51 through the inlet opening 52 and is forced to enter into the transversal channels 41, 42, 43, 44, 4m, 4n through their inlet sections 411, 421, 431, 441, 4m1, 4n1. Inside the transversal channels 41, 42, 43, 44, 4m, 4n the speed of the arc suppressing gas is conveniently increased as previously described so as to achieve the desired arc suppression effect.

In general, shape and numbers of the conveyor element 5 may vary depending on the design and positioning of the one or more transversal channel(s) 41, 42, 43, 44, 4m, 4n within the contact end portion 23 of the main contact element 21 of the movable contact assembly 2.

It is therefore clear from the above that the contact arrangement of the present disclosure, and the High and Medium Voltage fast-earthing switch including the contact arrangement as described herein, fully meet the intended aims and purposes.

1. A High and Medium Voltage switch contacts arrangement (100) comprising a fixed contact assembly and a movable contact assembly couplable to/un-couplable from said fixed contact assembly between a closed/open position,
wherein said fixed contact assembly comprises: a main contact group comprising a support element having a plurality of main contact elements circumferentially positioned to delimit a contact seat, and a pre-arching contact element comprising a central contact pin centrally positioned in said contact seat and having a terminal portion protruding outside said contact seat;
wherein said movable contact assembly (2) comprises a main contact element having an elongated body with a contact end portion configured to be inserted into/extracted from said contact seat with a linear movement, the external surface of said contact end portion configured to be in electrical contact with said main contact elements when inserted into said contact seat; and
wherein the contact end portion of the main contact element of the movable contact assembly comprises an opening and a first longitudinal channel configured to house the central contact pin of said movable contact assembly and further comprises one or more transversal channels conveying a quenching gas from the outside of the main contact element of the movable contact assembly into said first longitudinal channel at least during the opening operation of said movable contact assembly.

2. The High and Medium Voltage switch contacts arrangement, according to claim 1, wherein said one or more transversal channels have an inlet section on the external surface of the elongated body of the main contact element of the movable contact assembly and an outlet section on the internal surface of the first longitudinal channel.

3. The High and Medium Voltage switch contacts arrangement, according to claim 1, wherein said one or more transversal channels are inclined toward the opening of the contact end portion of the main contact element at an angle of less than 90°.

4. The High and Medium Voltage switch contacts arrangement, according to claim 1, wherein the contact end portion of the main contact element of the movable contact assembly comprises a plurality of transversal channels.

5. The High and Medium Voltage switch contacts arrangement, according to claim 1, wherein the contact end portion of the main contact element of the movable contact assembly comprises a plurality of transversal channels symmetrically positioned with respect to said first longitudinal channel.

6. The High and Medium Voltage switch contacts arrangement, according to claim 1, wherein the internal surfaces of said one or more transversal channels have a converging profile.

7. The High and Medium Voltage switch contacts arrangement, according to claim 2 wherein said one or more transversal channels, the area of the inlet section is greater than the area of the corresponding outlet section.

8. The High and Medium Voltage switch contacts arrangement, according to claim 1, wherein the one or more transverse channels have a nozzle-shaped outlet portion connected into the first longitudinal channel.

9. The High and Medium Voltage switch contacts arrangement, according to claim 1, wherein said movable contact assembly comprises a conveying flap configured to convey a quenching gas from the outside of the main contact element to an inlet section of said one or more transversal channels.

10. The High and Medium Voltage switch contacts arrangement, according to claim 9, wherein said conveying flap forms a closed cavity having an inlet opening in opposite direction with respect to the contact end portion of the main contact element of the movable contact assembly.

11. A High and Medium Voltage switch comprising the High and Medium Voltage switch contacts arrangement according to claim 1.

12. The High and Medium Voltage switch according to claim 11, wherein said switch is a fast-earthing switch.
